(19) United States
(12) Patent Application Publication
(10) Pub. No.: US 2010/0019692 A1
(43) Pub. Date: Jan. 28, 2010

(54) POWER CONVERSION APPARATUS

(75) Inventor: Kengo KIMURA, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/507,313

(22) Filed: Jul. 22, 2009

(30) Foreign Application Priority Data
Jul. 25, 2008 (JP) 2008-192112

(51) Int. Cl. H05B 41/36

(52) U.S. Cl. 315/294

(57) ABSTRACT

A power conversion apparatus includes a first DC converter to convert an AC voltage from an AC power source into a DC voltage and correct a power factor, a light emitting load to emit light under a predetermined DC voltage, a second DC converter to electrically insulate the first DC converter and the light emitting load from each other, convert the DC voltage from the first DC converter into the predetermined DC voltage, and supply the predetermined DC voltage to the light emitting load, a plurality of loads to operate under low DC voltages, and a third DC converter to electrically insulate the first DC converter and the plurality of loads from each other, convert the DC voltage from the first DC converter into low DC voltages, and supply the low DC voltages to the plurality of loads.

### BACKGROUND OF THE INVENTION

1. Field of the Invention

The present invention relates to a power conversion apparatus capable of reducing the number of power conversion stages, to reduce the cost of the apparatus and improve the efficiency thereof.

2. Description of the Related Art

FIG. 1 is a circuit diagram illustrating a power conversion apparatus according to a related art. In FIG. 1, a power source 1 (AC 80 to 260 V and 50 or 60 Hz) is connected to an LCD TV system 2i. The LCD TV system 2i includes a first DC converter 3′, a second DC converter 4′, a third DC converter 51, a backlight 6 having discharge tubes 60a and 60b, an LCD driver 8, an image processor 9, a speaker 10, and a DC-AC converter (inverter) 15 having a leakage-type transformer.

The first DC converter 3′ converts an AC voltage from the commercial power source 1 into a DC voltage of, for example, 380 V and corrects a power factor. The second DC converter 4′ works as a main power source, insulates primary and secondary sides from each other, and converts the DC voltage from the first DC converter 31 into a predetermined DC voltage of, for example, 24 V. The DC-AC converter 15 converts the DC voltage from the second DC converter 4′ into an AC voltage of, for example, 1500 Vrms of 65 kHz to light the discharge tubes 60a and 60b.

The second DC converter 4′ supplies the predetermined DC voltage to the LCD driver 8 and drives the same. The third DC converter 5′ electrically insulates the first DC converter 3′ and the image processor 9 and speaker 10 from each other and converts the DC voltage from the first DC converter 3′ into DC voltages of 12 V and 36 V, which are supplied to the image processor 9 and speaker 10, respectively.

In this way, the power conversion apparatus of FIG. 1 converts the AC power (voltage) from the commercial power source 1 into AC power of high voltage and high frequency to light the discharge tubes 60a and 60b.

Related arts are, for example, Japanese Unexamined Patent Application Publications No. 2005-71681 and No. H10-50489, U.S. Pat. No. 5,930,121 (second paragraph of Description of Preferred Embodiments), and U.S. Pat. No. 5,615,093 (FIG. 4).

### SUMMARY OF THE INVENTION

According to the power conversion apparatus of the related art illustrated in FIG. 1, there are three power conversion stages between the commercial power source 1 and the backlight 6 having the discharge tubes 60a and 60b that need the largest load power. Namely, the power conversion stage by the first DC converter 3′, the power conversion stage by the second DC converter 4′, and the power conversion stage by the DC-AC converter 15.

Power consumption of an LCD-TV is reducible by improving the brightness efficiency of a light source and the power conversion efficiency of each power conversion stage. On top of that, reducing the number of power conversion stages between a power source and the light source that consumes the largest power is crucial.

A light emitting diode (LED) is lighted with a DC voltage. A voltage (drive voltage) applied to an LED is determined by the IF-VF characteristic and temperature characteristic of the LED. Controlling the brightness of an LED, i.e., controlling a current passing through an LED causes some variation in a drive voltage of the LED. Accordingly, it is basically impossible to directly use a drive voltage to an LED as an input voltage to another load. A home appliance such as the TV set 2i of FIG. 1 is easily accessible by persons, and therefore, the commercial power source 1 and the backlight 6 must electrically be insulated from each other.

In the power conversion apparatus of FIG. 1, the second DC converter 4′ may be omitted to directly supply the output from the first DC converter 3′ to the DC-AC converter 15. In this case, the insulation must be carried out by the leakage-type transformer in the DC-AC converter 15 where input and output voltages are both high. This increases the cost of the transformer and a large amount of leakage flux from the transformer causes conductor patterns on peripheral circuit boards to produce eddy current losses. It is ideal, therefore, to carry out the primary-secondary insulation in any one of the DC converters.

The present invention provides a power conversion apparatus capable of converting an AC voltage from an AC power source into a DC voltage, driving an electrically insulated light emitting load with the converted DC voltage, reducing the number of power conversion stages between the AC power source and the load, decreasing the cost of the apparatus, and improving the efficiency of the apparatus.

According to a first aspect of the present invention, the power conversion apparatus includes a first DC converter configured to convert an AC voltage from an AC power source into a DC voltage and correct a power factor; a light emitting load configured to emit light under a predetermined DC voltage; a second DC converter configured to electrically insulate the first DC converter and the light emitting load from each other, convert the DC voltage from the first DC converter into the predetermined DC voltage, and supply the predetermined DC voltage to the light emitting load; a plurality of loads configured to operate under low DC voltages; and a third DC converter configured to electrically insulate the first DC converter and the plurality of loads from each other, convert the DC voltage from the first DC converter into at least one low DC voltage, and supply the at least one low DC voltage to at least one of the plurality of loads.

According to a second aspect of the present invention, the power conversion apparatus includes a first DC converter configured to electrically insulate an AC power source and a light emitting load that emits light under a predetermined DC voltage from each other, convert an AC voltage from the AC power source into the predetermined DC voltage, correct a power factor, and supply the predetermined DC voltage to the light emitting load; a plurality of loads configured to operate under low DC voltages; and a third DC converter configured to electrically insulate the AC power source and the plurality of loads from each other, convert the AC voltage from the AC power source into at least one low DC voltage, and supply it to at least one of the plurality of loads.

According to a third aspect of the present invention, the power conversion apparatus includes a second DC converter configured to electrically insulate an AC power source and a light emitting load that emits light under a predetermined DC voltage from each other, convert an AC voltage from the AC power source into the predetermined DC voltage, and supply the predetermined DC voltage to the light emitting load; a plurality of loads configured to operate under low DC voltages; and a third DC converter configured to electrically insulate the AC power source and the plurality of loads from each other, convert the AC voltage from the AC power source into at least one low DC voltage, and supply it to at least one of the plurality of loads.

### BRIEF DESCRIPTION OF THE DRAWINGS

FIG. 1 is a circuit diagram illustrating a power conversion apparatus according to a related art;

FIG. 2 is a circuit diagram illustrating a power conversion apparatus according to Embodiment 1 of the present invention;

FIG. 3 is a circuit diagram illustrating a second DC converter arranged in the power conversion apparatus of Embodiment 1;

FIG. 4 is a circuit diagram illustrating a first DC converter arranged in the power conversion apparatus of Embodiment 1;

FIG. 5 is a circuit diagram illustrating a third DC converter arranged in the power conversion apparatus of Embodiment 1;

FIG. 6 is a circuit diagram illustrating a power conversion apparatus according to Embodiment 2 of the present invention;

FIG. 7 is a circuit diagram illustrating a fourth DC converter arranged in the power conversion apparatus of Embodiment 2;

FIG. 8 is a circuit diagram illustrating a power conversion apparatus according to Embodiment 3 of the present invention;

FIG. 9 is a circuit diagram illustrating a power conversion apparatus according to Embodiment 4 of the present invention;

FIG. 10 is a circuit diagram illustrating a first DC converter arranged in the power conversion apparatus of Embodiment 4;

FIG. 11 is a circuit diagram illustrating a power conversion apparatus according to Embodiment 5 of the present invention;

FIG. 12 is a circuit diagram illustrating a power conversion apparatus according to Embodiment 6 of the present invention;

FIG. 13 is a circuit diagram illustrating a power conversion apparatus according to Embodiment 7 of the present invention;

FIG. 14 is a circuit diagram illustrating a second DC converter arranged in the power conversion apparatus of Embodiment 7;

FIG. 15 is a circuit diagram illustrating a power conversion apparatus according to Embodiment 8 of the present invention; and

FIG. 16 is a circuit diagram illustrating a power conversion apparatus according to Embodiment 9 of the present invention;

### DESCRIPTION OF THE PREFERRED EMBODIMENT

Power conversion apparatuses according to embodiments of the present invention will be explained in detail with reference to the drawings.

### Embodiment 1

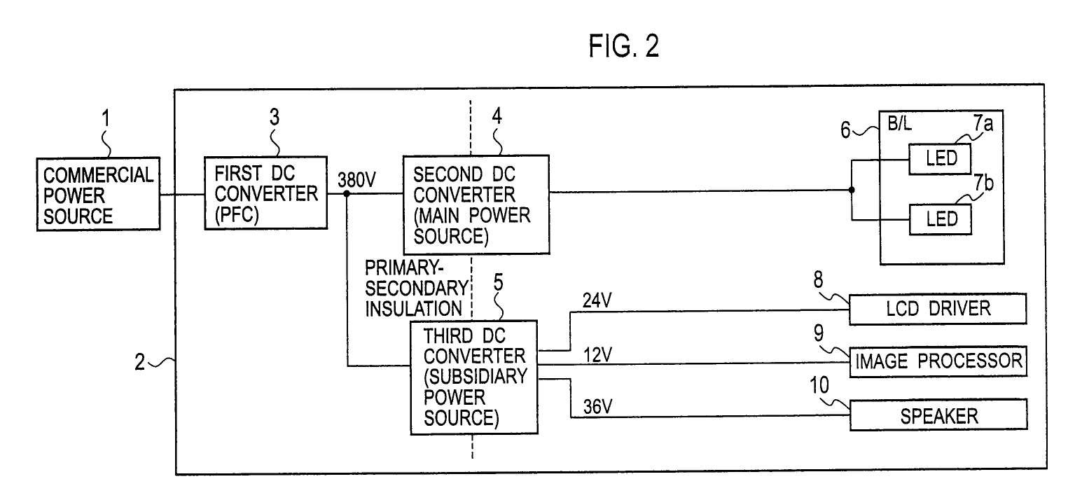

FIG. 2 is a circuit diagram illustrating a power conversion apparatus according to Embodiment 1 of the present invention. This power conversion apparatus involves a commercial power source (AC power source) 1 and an LCD (liquid crystal display) TV system 2. The LCD TV system 2 includes a first DC converter 3, a backlight 6 having a plurality of LEDs (light emitting diodes) 7a and 7b that serve as light emitting loads and emit light under a predetermined DC voltage, a second DC converter 4, and a third DC converter 5.

The first DC converter 3 converts an AC voltage from the commercial power source 1 into a DC voltage of, for example, 380 V and corrects a power factor. The second DC converter 4 works as a main power source, electrically insulates the first DC converter 3 and the backlight 6 having the LEDs 7a and 7b from each other, converts the DC voltage from the first DC converter 3 into the predetermined DC voltage, and supplies the predetermined DC voltage to the LEDs 7a and 7b.

An LCD driver 8, an image processor 9, and a speaker 10 are a plurality of loads. The LCD driver 8 operates under a DC voltage of 24 V, the image processor 9 operates under a DC voltage of 12 V, and the speaker 10 operates under a DC voltage of 36 V.

The third DC converter 5 works as a subsidiary power source, electrically insulates the first DC converter 3 and the plurality of loads 8 to 10 from each other, converts the DC voltage from the first DC converter 3 into a plurality of low DC voltages of 24 V, 12 V, and 36 V, and supplies the low DC voltages to the LCD driver 8, image processor 9, and speaker 10, respectively.

Although Embodiment 1 employs LEDs as the light emitting loads, any light emitting elements that operate under a given DC voltage are employable as the light emitting loads. For example, EL (electroluminescence) elements and FED (field emission display) elements are employable as the light emitting loads.

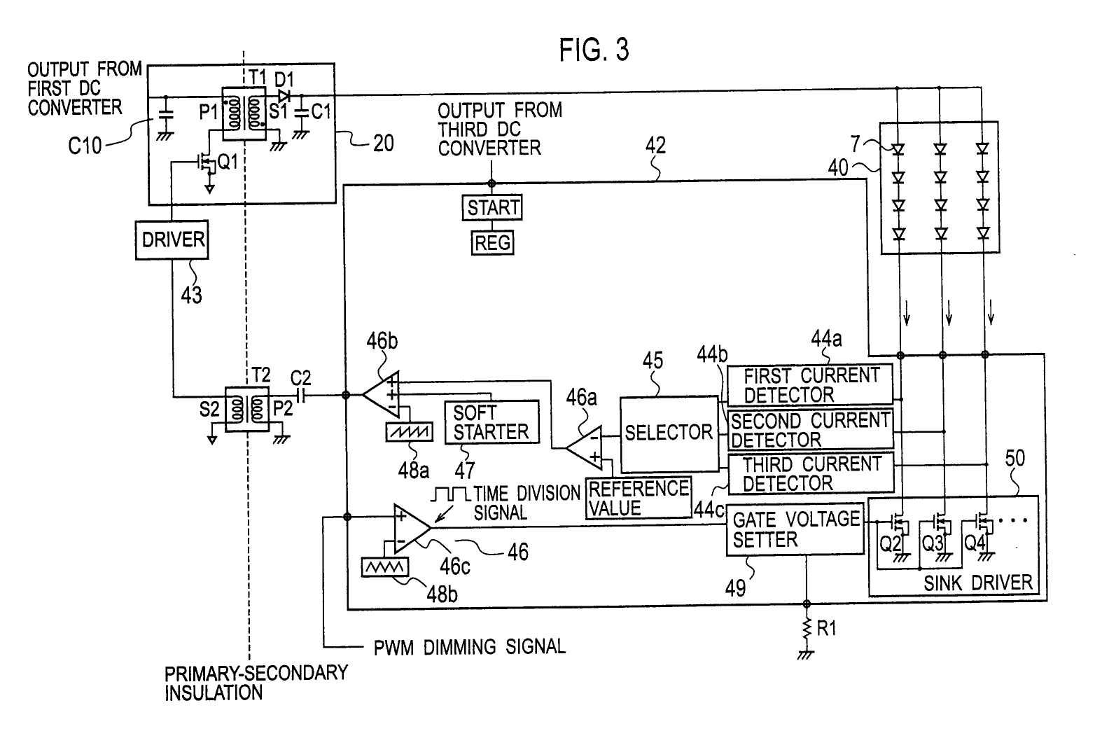

FIG. 3 is a circuit diagram illustrating the second DC converter 4 arranged in the power conversion apparatus of the present embodiment. The second DC converter 4 includes a flyback-type converter 20 having a transformer T1. The transformer T1 has a primary winding P1 and a secondary winding S1 to electrically insulate primary and secondary sides from each other. The second DC converter 4 may employ a forward-type converter including a transformer to electrically insulate primary and secondary sides from each other.

The second DC converter 4 incorporates the converter 20, a controller 42, and a resistor R1 for setting gate voltage of a sink driver 50.

An LED group load 7 in FIG. 3 corresponds to the backlight 6 having the LEDs 7a and 7b of FIG. 2. The LED group load 7 includes LED groups each including LEDs connected in series, the LED groups being connected in parallel with one another. In FIG. 3, the LED group load 7 includes three LED groups. The number of LED groups connected in parallel in the LED group load 7 is optional. The LED group load 7 is connected between an output side of the converter 20 and the sink driver 50 incorporated in the controller 42.

The converter 20 outputs a voltage according to a PWM control signal provided by the controller 42. The output voltage from the converter 20 is applied to anodes of the LED group load 7.

The controller 42 includes first to third current detectors 44a to 44c, a selector 45, an error amplifier 46a, a PWM control comparator 46b, a time division circuit 46, a soft starter 47, a sawtooth signal generator 48a, a gate voltage setter 49, and the sink driver 50.

The time division circuit 46 is arranged on the secondary side of the transformer T1, to generate a time division signal that turns on/off according to a duty determined by a DC PWM dimming signal that is externally provided. The time division circuit 46 includes a triangular signal generator 48b and a PWM dimming comparator (pulse converter) 46c. The triangular signal generator 48b generates a triangular signal and sends the same to the PWM dimming comparator 46c. The PWM dimming comparator 46c has a non-inverting input terminal (depicted by “+”) to receive the external PWM dimming signal and an inverting input terminal (depicted by “−”) to receive the triangular signal from the triangular signal generator 48b, compares the received signals with each other, and generates a rectangular time division signal according to a result of the comparison. The time division signal from the time division circuit 46 is sent to the gate voltage setter 49, to turn on/off a gate signal supplied from the gate voltage setter 49 to the sink driver 50.

The gate voltage setter 49 generates the gate signal according to the time division signal from the time division circuit 46 and a voltage set by the resistor R1 and sends the gate signal to the sink driver 50.

The sink driver 50 includes a plurality of MOSFETs (Q2, Q3, Q4, . . . ), those correspond to the LED groups in the LED group load 7, respectively. Gates of the MOSFETs are connected to the gate voltage setter 49, drains thereof to cathodes of the LED group load 7, and sources thereof to the ground. The MOSFETs in the sink driver 50 turn on in response to the gate signal from the gate voltage setter 49 during an ON period of the time division signal, to supply currents to the LED group load 7 and cause the LEDs to emit light. The MOSFETs in the sink driver 50 turn off in response to the gate signal from the gate voltage setter 49 during an OFF period of the time division signal, to stop currents to the LED group load 7 and stop the LEDs from emitting light.

The brightness of the LED group load 7 is adjustable according to the ON/OFF duty ratio of the time division signal, i.e., according to the DC PWM dimming signal that is externally provided.

The currents passing through the three lines of the LED group load 7 during an ON period of the time division signal are not equal to one another because there are VF (forward voltage) variations in the LEDs.

The first to third current detectors 44a to 44c are arranged on the secondary side of the transformer T1, to detect currents passing through the three lines of the LED group load 7 to the sink driver 50 and each generates current detected signals representative of each current. The selector 45 receives the three current detected signals from the first to third current detectors 44a to 44c, selects one of the current detected signals, and sends the selected signal to the error amplifier 46a.

The current detected signal selected by the selector 45 may be, for example, a largest one or a smallest one among the three current detected signals.

The error amplifier 46a is arranged on the secondary side of the transformer T1 and has an inverting input terminal (depicted by “−”) to receive the selected signal from the selector 45 and a non-inverting input terminal (depicted by “+”) to receive a reference voltage. The error amplifier 46a compares the voltage of the selected signal with the reference voltage, amplifies an error between the compared voltages, and sends the amplified error as a current feedback signal to the PWM control comparator 46b.

The soft starter 47 generates a soft start signal at the start of the controller 42. The soft start signal is a signal whose voltage gradually increases from a low voltage (for example, 0 V) and is sent to the PWM control comparator 46b.

The sawtooth signal generator 48a generates a sawtooth signal and sends the same to the PWM control comparator 46b. The PWM control comparator 46b generates a rectangular PWM control signal according to the current feedback signal from the error amplifier 46a, the soft start signal from the soft starter 47, and the sawtooth signal from the sawtooth signal generator 48a.

In a given period after the start of the controller 42, the PWM control comparator 46b compares the soft start signal from the soft starter 47 with the sawtooth signal from the sawtooth signal generator 48a and generates a PWM control signal whose pulse width gradually widens. When the LED group load 7 starts to emit light, the error amplifier 46a starts to send a current feedback signal. Then, the PWM control comparator 46b compares the current feedback signal from the error amplifier 46a with the sawtooth signal from the sawtooth signal generator 48a and generates a PWM control signal that is based on a current passing through the LED group load 7.

A transformer T2 (a signal transmission insulating element) has a primary winding P2 and a secondary winding S2 and transfers the PWM control signal to a drive 43 that is on the primary side. A switching element Q1 in the converter 20 is a MOSFET and is connected in series with the primary winding P1 of the transformer T1 that is connected to the output of the first DC converter 3. The driver 43 is arranged on the primary side of the transformer T1 and turns on/off the switching element Q1 according to the PWM control signal from the transformer T2, to thereby transmit power through the transformer T1 from the primary side to the secondary side.

A diode D1 and a capacitor C1 form a rectifying-smoothing circuit in the converter 20 to rectify and smooth an output voltage from the converter 20.

In this way, ON/OFF of the switching element Q1 is controlled according to a current passing through the LED group load 7 so as to keep the current passing through the LED group load 7 at a predetermined value, thereby constantly supplying necessary power to the LED group load 7.

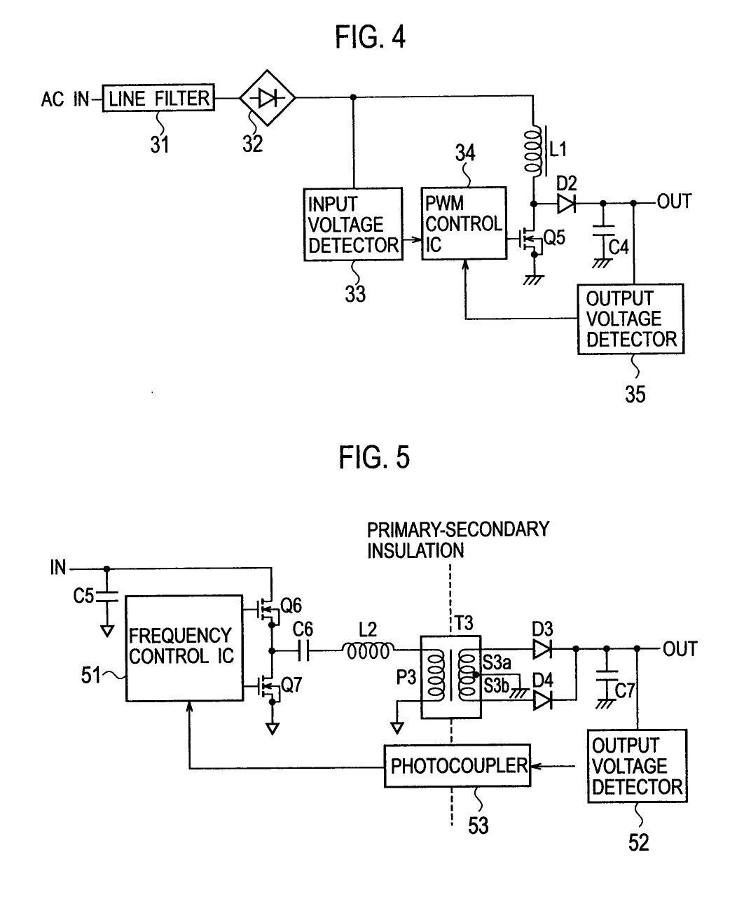

FIG. 4 is a circuit diagram illustrating the first DC converter 3 arranged in the power conversion apparatus of the present embodiment. In FIG. 4, a rectifier 32 receives through a line filter 31 the AC voltage of the commercial power source 1, rectifies the AC voltage, and outputs a rectified voltage. When a PWM control IC 34 turns on a switching element Q5, a current passes through a path extending along a step-up reactor L1 due to the rectified voltage, the switching element Q5, and the ground, to accumulate energy in the step-up reactor L1. When the switching element Q5 is turned off, the energy accumulated in the step-up reactor L1 and the rectified voltage are supplied through a diode D2 to a smoothing capacitor C4, to provide a stepped-up DC voltage.

An input voltage detector 33 detects the rectified voltage and outputs the detected voltage to the PWM control IC 34. An output voltage detector 35 detects the output voltage of the smoothing capacitor C4 and outputs the detected voltage to the PWM control IC 34. According to the detected output voltage, the PWM control IC 34 controls ON/OFF of the switching element Q5 in such a way as to keep the output voltage at a predetermined value. At the same time, the PWM control IC 34 controls a peak current passing through the switching element Q5 in such a way as to make the peak current proportional to a waveform of the rectified voltage detected by the input voltage detector 33, thereby correcting a power factor.

The first DC converter 3 illustrated in FIG. 4 employs a DCM (discontinuous current mode) that is a kind of a step-up chopper. The first DC converter 3 may employ any mode having a power factor correcting function, such as a CCM (continuous current mode), an interleave mode, and a passive PFC (power factor correction) mode.

FIG. 5 is a circuit diagram illustrating the third DC converter 5 arranged in the power conversion apparatus of the present embodiment. The third DC converter 5 is a forward-type converter including a transformer T3 that has a primary winding P3 and secondary windings S3a and S3b, to insulate primary and secondary sides from each other.

On the input side of the third DC converter 5, i.e., on the output side of the first DC converter 3, there is connected a series circuit including switching elements Q6 and Q7 that are MOSFETs. A connection point of the switching elements Q6 and Q7 is connected to a series circuit including a capacitor C6, a reactor L2, and the primary winding P3 of the transformer T3.

When a frequency control IC 51 turns off the switching element Q7 and on the switching element Q6, a current passes through a path extending along IN (power source), Q6, C6, L2, and P3 in the primary side and a current passes through a path extending along S3a, D3, and C7 in the secondary side. When the frequency control IC 51 turns off the switching element Q6 and on the switching element Q7, a current passes through a path extending along P3, L2, C6, and Q7 in the primary side and a current passes through a path extending along S3b, D4, and C7 in the secondary side.

An output voltage detector 52 detects an output voltage from the capacitor C7 and transfers the detected voltage through a photocoupler 53 to the frequency control IC 51. According to the output voltage of the capacitor C7, the frequency control IC 51 controls ON/OFF of the switching elements Q6 and Q7 so as to keep the output voltage of the capacitor C7 at a predetermined value.

The third DC converter 5 may be of any type if it has an insulating function, such as a flyback type and a resonant type.

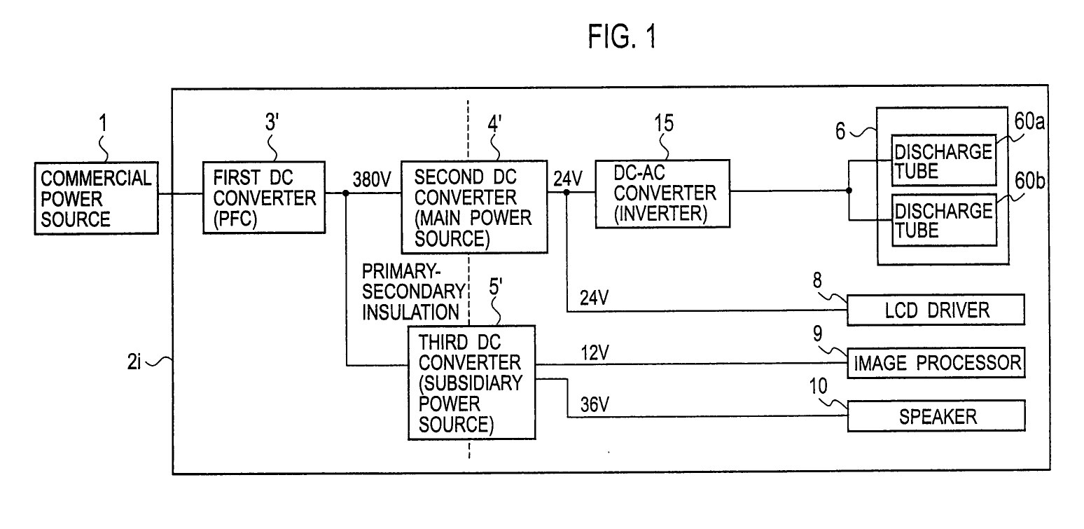

In this way, the power conversion apparatus according to the present embodiment employs the first DC converter 3 and second DC converter 4 to convert an AC voltage from the commercial power source 1 into a DC voltage to make the LEDs 7a and 7b emit light. Namely, Embodiment 1 reduces the number of power conversion stages between the commercial power source 1 and the LEDs 7a and 7b by one compared to the related art illustrated in FIG. 1, thereby reducing the cost of the power conversion apparatus and improving the efficiency thereof.

In addition, Embodiment 1 insulates the primary and secondary sides from each other at the second DC converter 4. This configuration reduces the cost of the power conversion apparatus and secures the efficiency thereof compared to the related art of FIG. 1 that insulates the primary and secondary sides from each other at the DC-AC converter 15.

### Embodiment 2

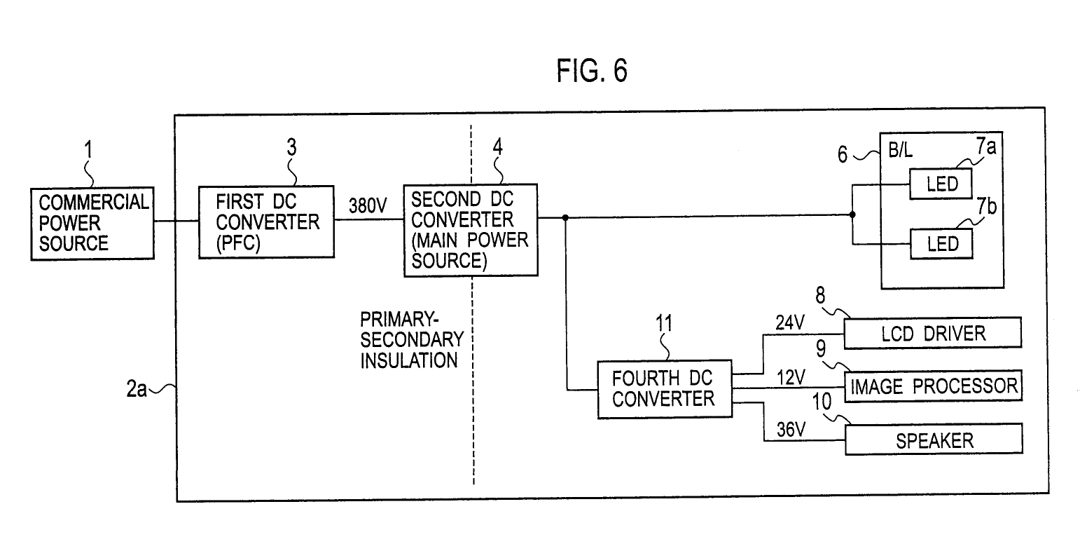

FIG. 6 is a circuit diagram illustrating a power conversion apparatus according to Embodiment 2 of the present invention. This power conversion apparatus includes an LCD TV system 2a that omits the third DC converter 5 of Embodiment 1 illustrated in FIG. 2, connects an output side of a second DC converter 4 to a fourth DC converter 11, and connects an output side of the fourth DC converter 11 to an LCD driver 8, an image processor 9, and a speaker 10.

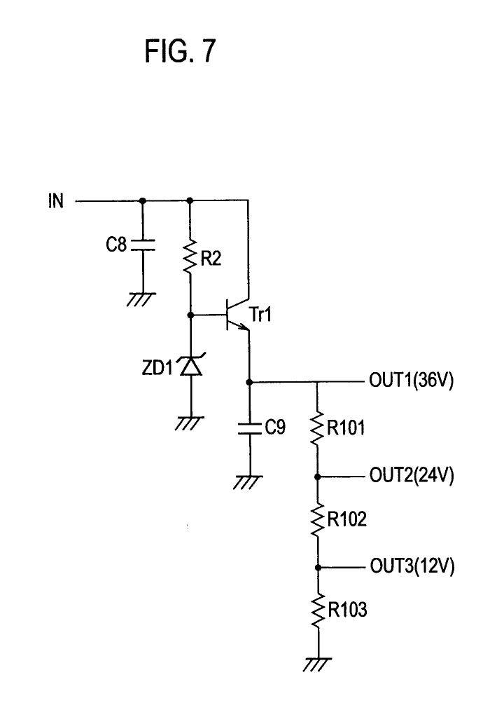

FIG. 7 is a circuit diagram illustrating the fourth DC converter 11 arranged in the power conversion apparatus of the present embodiment. In the fourth DC converter 11 of FIG. 7, a first end of a capacitor C8, a first end of a resistor R2, and a collector of a transistor Tr1 are connected to an output side IN of the second DC converter 4. A second end of the resistor R2, a base of the transistor Tr1, and a cathode of a Zener diode ZD1 are connected together. An emitter of the transistor Tr1 is connected to a first end of a resistor R101 and a first end of a capacitor C9. A second end of the resistor R101 is connected to a first end of a resistor R102. A second end of the resistor R102 is connected to a first end of a resistor R103. Second ends of the capacitors C8 and C9, a second end of the resistor R103, and an anode of the Zener diode ZD1 are grounded.

A connection point between the emitter of the transistor Tr1 and the capacitor C9 provides a DC voltage OUT1. A connection point between the resistors R101 and R102 provides a DC voltage OUT2. A connection point between the resistors R102 and R103 provides a DC voltage OUT3.

In this way, Embodiment 2 provides the same effect as Embodiment 1.

### Embodiment 3

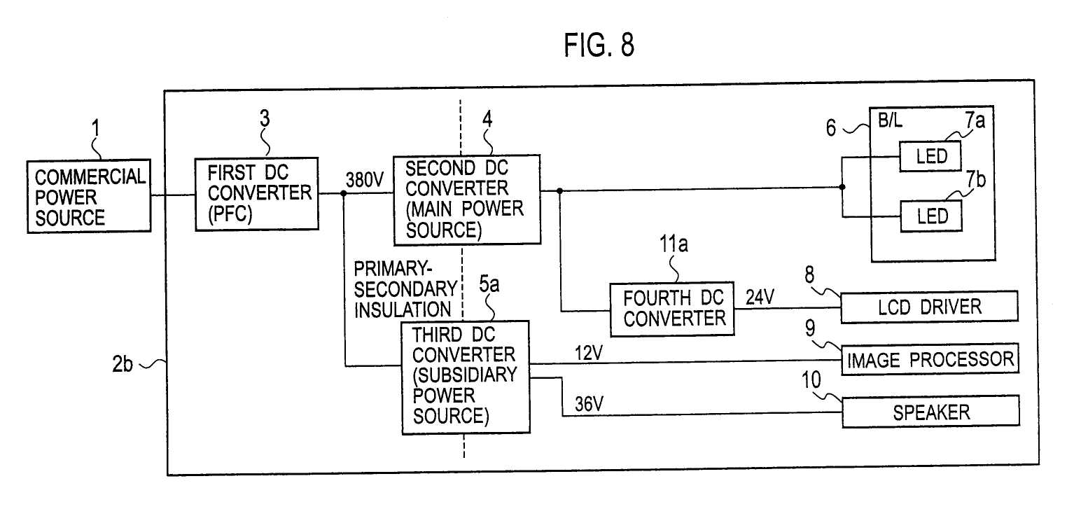

FIG. 8 is a circuit diagram illustrating a power conversion apparatus according to Embodiment 3 of the present invention. This power conversion apparatus includes an LCD TV system 2b. Compared to the LCD TV system 2 of Embodiment 1 illustrated in FIG. 2, the LCD TV system 2b of Embodiment 3 connects an LCD driver 8 to an output side of a fourth DC converter 11a instead of a third DC converter 5a. The fourth DC converter 11a converts an output DC voltage from a second DC converter 4 into a low DC voltage to drive the LCD driver 8. Embodiment 3 provides the same effect as Embodiment 1.

### Embodiment 4

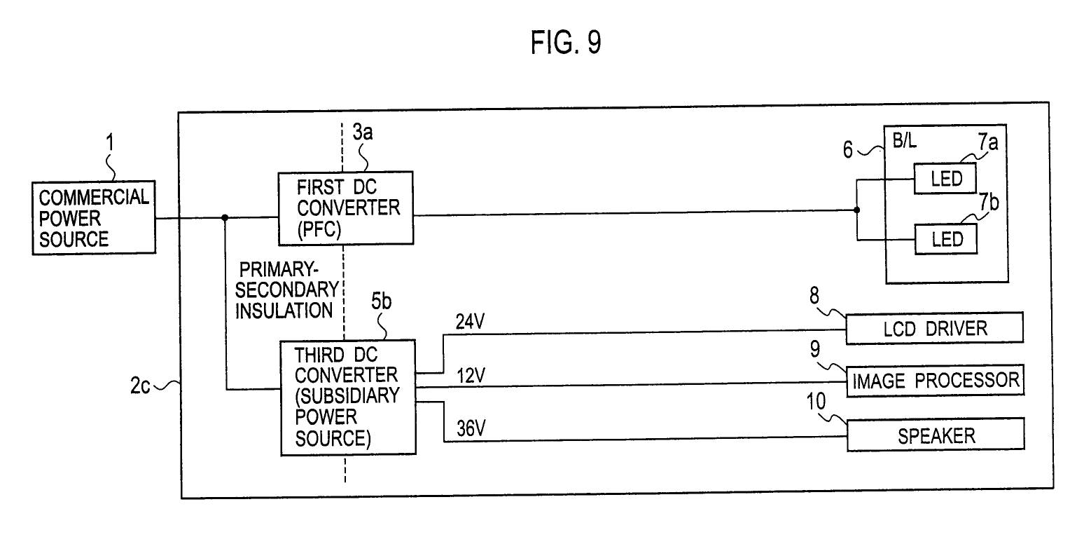

FIG. 9 is a circuit diagram illustrating a power conversion apparatus according to Embodiment 4 of the present invention. This power conversion apparatus involves a commercial power source (AC power source) 1 and an LCD TV system 2c. The LCD TV system 2c includes a first DC converter 3a, a backlight 6 having a plurality of LEDs 7a and 7b, a third DC converter 5b, an LCD driver 8, an image processor 9, and a speaker 10.

The first DC converter 3a electrically insulates the commercial power source 1 and the LEDs 7a and 7b from each other, converts an AC voltage from the commercial power source 1 into a DC voltage of, for example, 380 V, corrects a power factor, and supplies the DC voltage to the LEDs 7a and 7b to make the LEDs 7a and 7b emit light.

The third DC converter 5b electrically insulates the commercial power source 1 and the plurality of loads 8 to 10 from each other, converts the AC voltage from the commercial power source 1 into a plurality of low DC voltages of 24 V, 12 V, and 36 V, and supplies the low DC voltages to the LCD driver 8, image processor 9, and speaker 10, respectively.

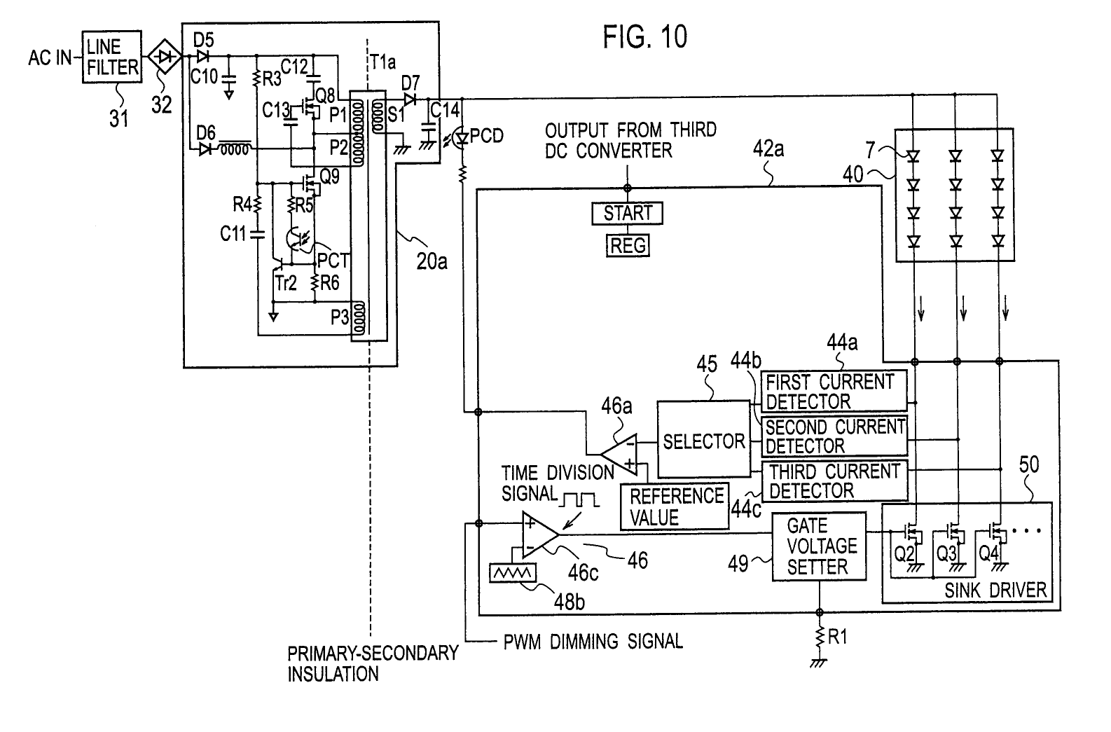

FIG. 10 is a circuit diagram illustrating the first DC converter 3a arranged in the power conversion apparatus of the present embodiment. The first DC converter 3a has a converter 20a that includes a transformer T1a having a primary winding P1, a secondary winding S1, and auxiliary windings P2 and P3, to insulate the primary and secondary sides from each other.

More precisely, the first DC converter 3a includes a line filter 31, a rectifier 32, the converter 20a, a controller 42a, and a resistor for setting gate voltage R1. An LED group load 7 corresponds to the backlight 6 of FIG. 9 having the plurality of LEDs 7a and 7b acting as light emitting loads. The LED group load 7 is connected between an output side of the converter 20a and a sink driver 50 incorporated in the controller 42a.

The AC voltage of the commercial power source 1 is rectified by the rectifier 32 through the line filter 31. The rectified voltage is sent to the converter 20a including switching elements Q8 and Q9, which are MOSFETs, and the transformer T1a.

The converter 20a is a self-exciting, two-switching-element converter having a power factor correcting function and has the switching elements Q8 and Q9 that are alternately turned on/off. According to a current feedback signal sent from the controller 42a, the converter 20a controls an ON period (off timing) of the switching element Q9, to provide the DC voltage necessary for the LED group load 7. The output voltage from the converter 20a is applied to anodes of the LED group load 7.

The controller 42a includes first to third current detectors 44a to 44c, a selector 45, an error amplifier 46a, a time division circuit 46, a gate voltage setter 49, and the sink driver 50.

The time division circuit 46, gate voltage setter 49, sink driver 50, first to third current detectors 44a to 44c, and selector 45 are the same as those of FIG. 3, and therefore, will not be explained again.

The error amplifier 46a is arranged on the secondary side of the transformer T1a, has an inverting input terminal (depicted by “−”) to receive a voltage sent from the selector 45 and a non-inverting input terminal (depicted by “+”) to receive a reference voltage, amplifies an error between the received voltages, and sends the amplified error as a current feedback signal to a diode PCD of a photocoupler PC.

In response to the current feedback signal, the diode PCD of the photocoupler PC emits light, which is received on the primary side by a transistor PCT of the photocoupler PC. Namely, the photocoupler PC transfers the current feedback signal to the primary side. According to the current feedback signal sent to the primary side, an ON period (off timing) of the switching element Q9 is determined, and accordingly, the switching elements Q8 and Q9 are turned on and off to transmit power needed by the LED group load 7 from the primary side to the secondary side.

The first DC converter 3a may be any DC converter having an insulating function, a step-up function, and a power factor correcting function, such as an externally-excited, two-switching-element converter (an active clamp converter).

In this way, the power conversion apparatus according to the present embodiment employs the first DC converter 3a to convert an AC voltage of the commercial power source 1 into a DC voltage to make the LEDs 7a and 7b emit light. Compared to the related art of FIG. 1, Embodiment 4 reduces the number of power conversion stages between the commercial power source 1 and the LEDs 7a and 7b by two, to reduce the cost of the apparatus and improve the efficiency thereof.

Embodiment 4 insulates the primary and secondary sides from each other at the first DC converter 3a. This configuration reduces the cost of the power conversion apparatus and secures the efficiency thereof compared to the related art of FIG. 1 that insulates the primary and secondary sides from each other at the DC-AC converter 15.

### Embodiment 5

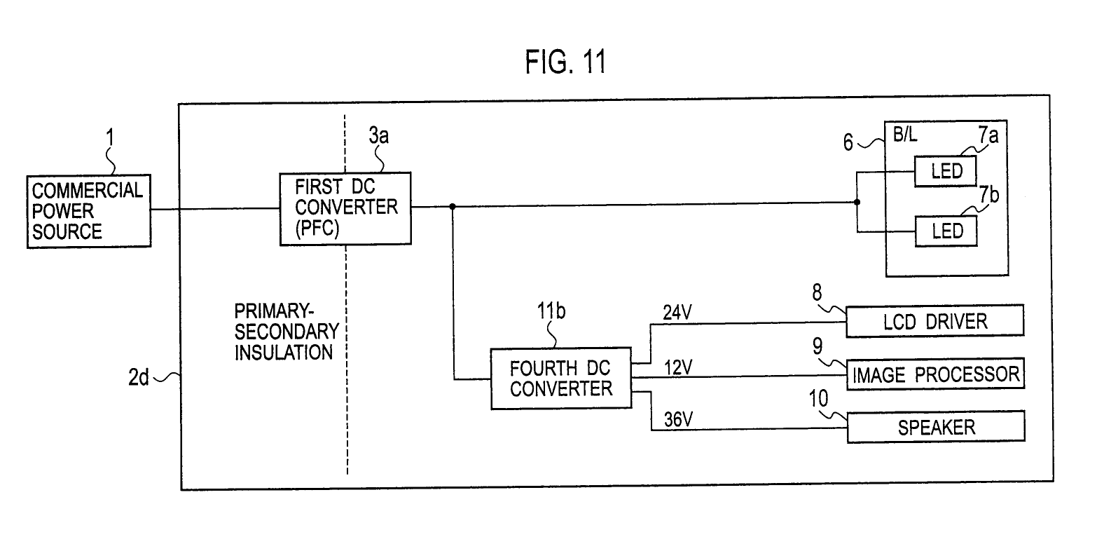

FIG. 11 is a circuit diagram illustrating a power conversion apparatus according to Embodiment 5 of the present invention. This power conversion apparatus includes an LCD TV system 2d. The LCD TV system 2d omits the third DC converter 5b of Embodiment 4 illustrated in FIG. 9, connects a fourth DC converter 11b to an output side of a first DC converter 3a, and connects an output side of the fourth DC converter 11b to an LCD driver 8, an image processor 9, and a speaker 10. Embodiment 5 provides the same effect as Embodiment 4.

### Embodiment 6

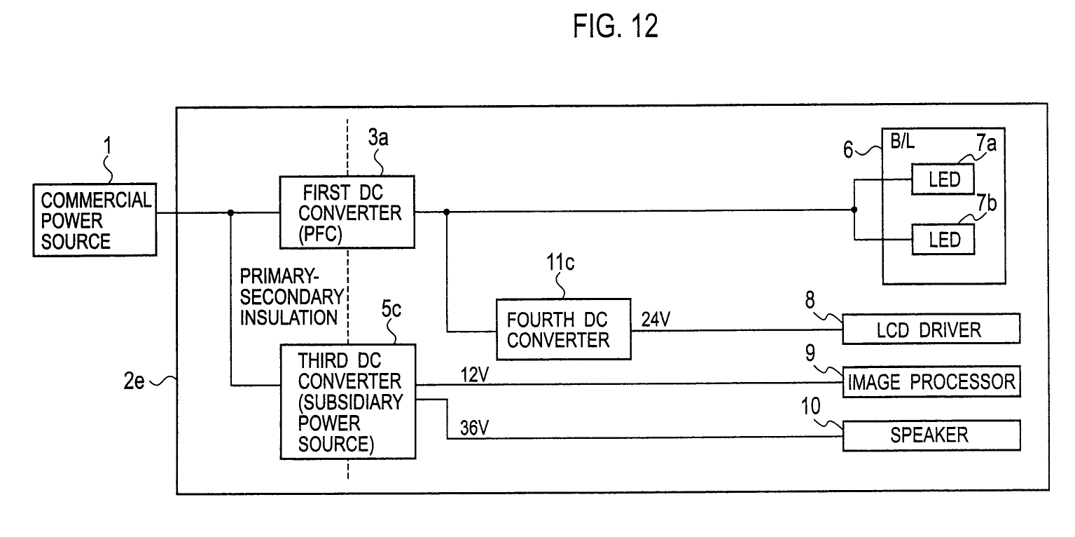

FIG. 12 is a circuit diagram illustrating a power conversion apparatus according to Embodiment 6 of the present invention. This power conversion apparatus involves an LCD TV system 2e. The LCD TV system 2e connects an LCD driver 8 to an output side of a fourth DC converter 11c instead of the third DC converter 5b of Embodiment 4 illustrated in FIG. 9, the fourth DC converter 11c converting a DC voltage provided by a first DC converter 3a into a low DC voltage to drive the LCD driver 8. Embodiment 6 provides the same effect as Embodiment 4.

### Embodiment 7

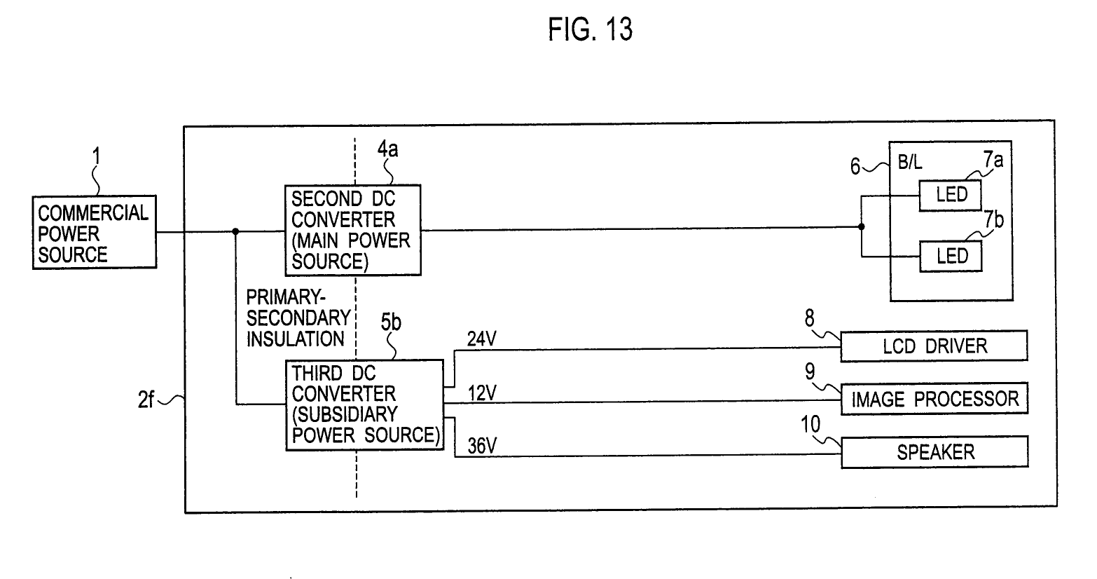

FIG. 13 is a circuit diagram illustrating a power conversion apparatus according to Embodiment 7 of the present invention. This power conversion apparatus involves a commercial power source (AC power source) 1 and an LCD TV system 2f. The LCD TV system 2f includes a second DC converter 4a, a backlight 6 having a plurality of LEDs 7a and 7b, a third DC converter 5b, an LCD driver 8, an image processor 9, and a speaker 10.

The second DC converter 4a electrically insulates the commercial power source 1 and the LEDs 7a and 7b from each other, converts an AC voltage from the commercial power source 1 into a DC voltage, and supplies the DC voltage to the LEDs 7a and 7b, to make the LEDs 7a and 7b emit light.

The third DC converter 5b electrically insulates the commercial power source 1 and the loads 8 to 10 from each other, converts the AC voltage from the commercial power source 1 into low DC voltages of 24 V, 12 V, and 36 V, and supplies the low DC voltages to the LCD driver 8, image processor 9, and speaker 10, respectively.

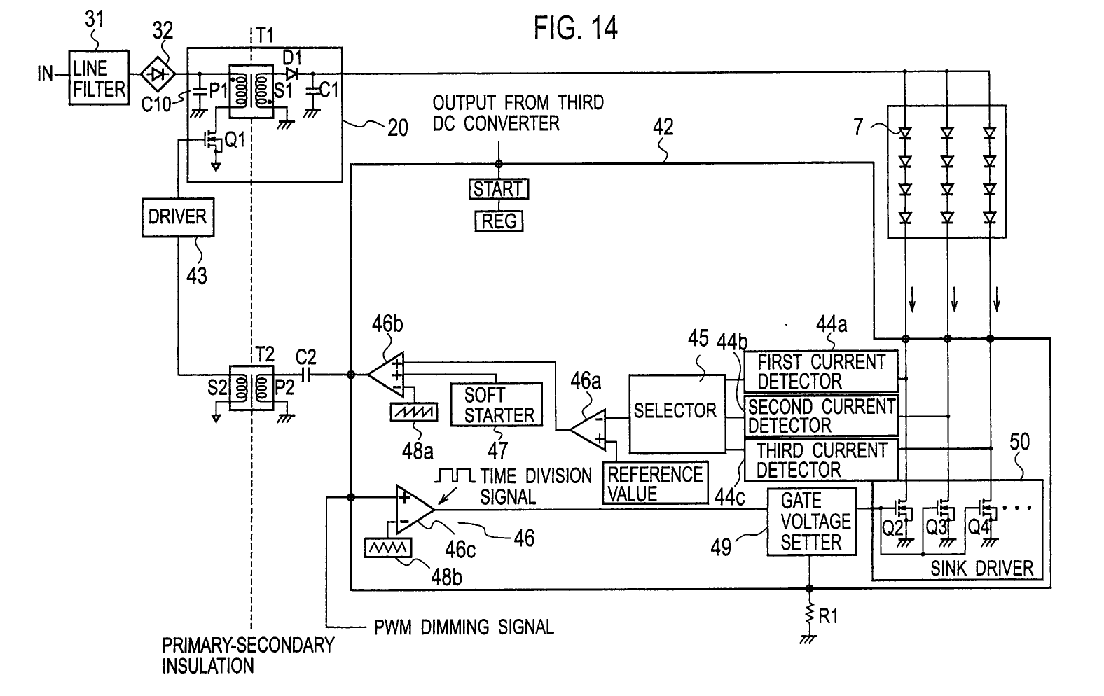

FIG. 14 is a circuit diagram illustrating the second DC converter 4a arranged in the power conversion apparatus of the present embodiment. The second DC converter 4a of FIG. 14 differs from the second DC converter 4 of Embodiment 1 illustrated in FIG. 3 in that it additionally has a line filter 31 and a rectifier 32 on the input side. The other parts of the second DC converter 4a are the same as those of the second DC converter 4 of Embodiment 1.

The present embodiment is applicable when the total power consumption of the power conversion apparatus is lower than, for example, 75 W and needs no countermeasures for harmonics. The power conversion apparatus of the present embodiment employs the second DC converter 4a to convert an AC voltage from the commercial power source 1 into a DC voltage and supplies the DC voltage to the LEDs 7a and 7b, to make the LEDs 7a and 7b emit light. This configuration reduces the number of power conversion stages between the commercial power source 1 and the LEDs 7a and 7b, to reduce the cost of the apparatus and improve the efficiency thereof.

In addition, Embodiment 7 insulates the primary and secondary sides from each other at the second DC converter 4a. This configuration reduces the cost of the power conversion apparatus and secures the efficiency thereof compared to the related art of FIG. 1 that insulates the primary and secondary sides from each other at the DC-AC converter 15.

### Embodiment 8

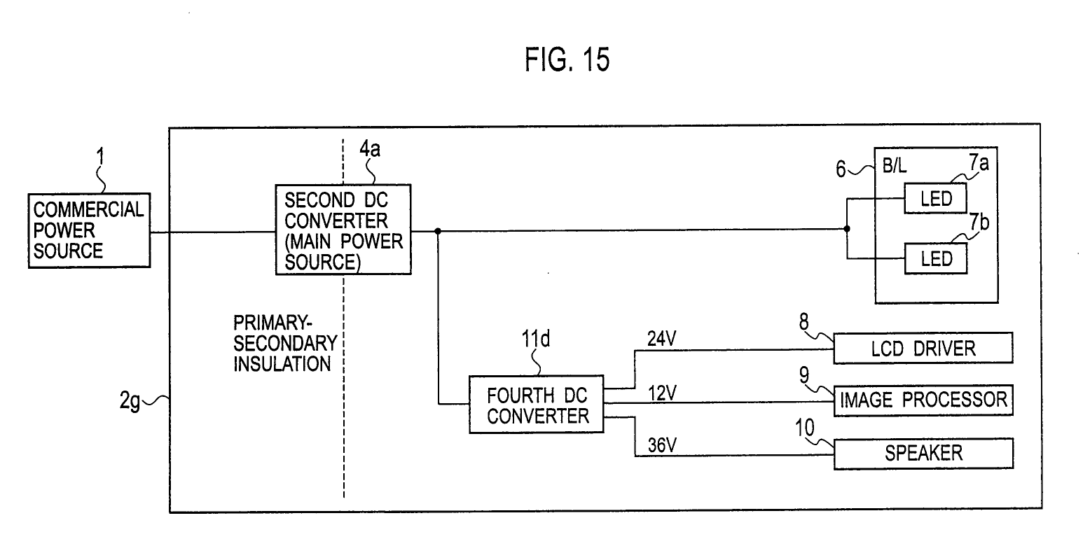

FIG. 15 is a circuit diagram illustrating a power conversion apparatus according to Embodiment 8 of the present invention. This power conversion apparatus involves an LCD TV system 2g. The LCD TV system 2g omits the third DC converter 5b of Embodiment 7 illustrated in FIG. 13, connects a fourth DC converter 11d to an output side of a second DC converter 4a, and connects an output side of the fourth DC converter 11d to an LCD driver 8, an image processor 9, and a speaker 10. Embodiment 8 provides the same effect as Embodiment 7.

### Embodiment 9

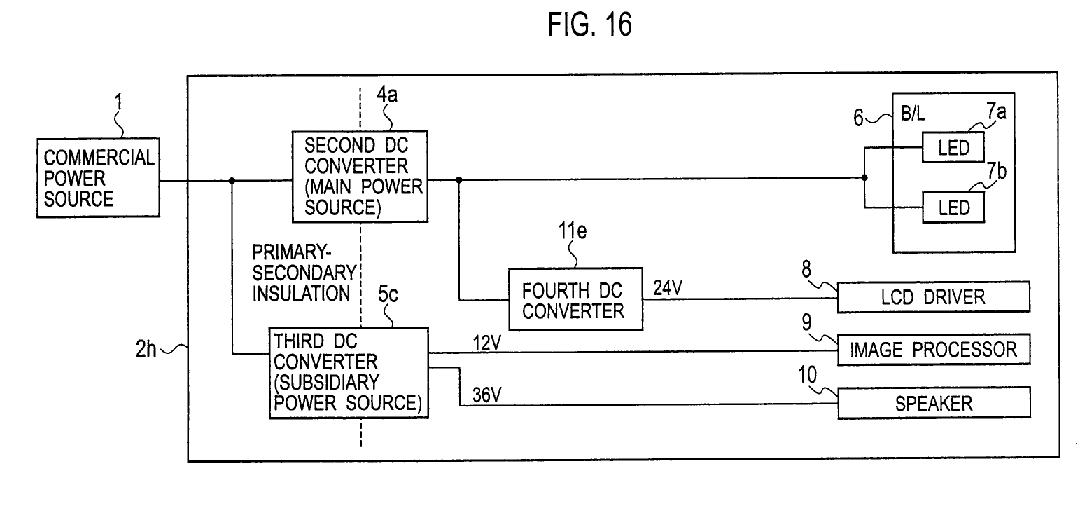

FIG. 16 is a circuit diagram illustrating a power conversion apparatus according to Embodiment 9 of the present invention. This power conversion apparatus involves an LCD TV system 2h. The LCD TV system 2h connects an LCD driver 8 to an output side of a fourth DC converter 11e instead of the third DC converter 5b of Embodiment 7 illustrated in FIG. 13, so that the fourth DC converter 11e converts a DC voltage from a second DC converter 4a into a low DC voltage to drive the LCD driver 8. Embodiment 9 provides the same effect as Embodiment 7 and those can be combined. The third DC converter 5b and the fourth DC converter 11d are selectable to each of those loads 8-10. That is, at least one of the loads 8-10 can be connected to the third DC converter 5b and at least another of the loads 8-10 can be connected to the forth DC converter 11d.

As mentioned above, the power conversion apparatus of each embodiment of the present invention is capable of converting an AC voltage of an AC power source into a DC voltage to drive an electrically insulated light emitting load and reducing the number of power conversion stages between the AC power source and the light emitting load. As a result, the power conversion apparatus is highly efficient and is manufacturable at low cost.

This application claims benefit of priority under 35 USC §119 to Japanese Patent Application No. 2008-192112, filed on Jul. 25, 2008, the entire content of which is incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A power conversion apparatus comprising:
a first DC converter configured to convert an AC voltage from an AC power source into a DC voltage and correct a power factor;
a light emitting load configured to emit light under a predetermined DC voltage;
a second DC converter configured to electrically insulate the first DC converter and the light emitting load from each other, convert the DC voltage from the first DC converter into the predetermined DC voltage, and supply the predetermined DC voltage to the light emitting load;
a plurality of loads configured to operate under low DC voltages; and
a third DC converter configured to electrically insulate the first DC converter and the plurality of loads from each other, convert the DC voltage from the first DC converter into at least one low DC voltage, and supply the at least one low DC voltage to at least one of the plurality of loads.

2. The power conversion apparatus of claim 1, further comprising:
a fourth DC converter configured to convert the predetermined DC voltage from the second DC converter into at least one low DC voltage to drive at least one of the plurality of loads,
the at least one of the plurality of loads being connected to an output side of the fourth DC converter.

3. The power conversion apparatus of claim 1, wherein the second DC converter comprises:
a transformer configured to insulate primary and secondary sides from each other;
a current detector arranged on the secondary side of the transformer and configured to detect a current passing through the light emitting load;
an error amplifier configured to amplify an error between the current value detected by the current detector and a reference current value;
a signal transmission insulating element configured to transmit a control signal based on an output signal of the error amplifier to the primary side of the transformer; and
a switching element arranged on the primary side of the transformer and configured to turn on/off according to the control signal transmitted from the signal transmission insulating element, to transmit power through the transformer to the secondary side of the transformer.

4. The power transmission apparatus of claim 3, wherein the second DC converter further comprises
a time division circuit arranged on the secondary side of the transformer and configured to intermittently supply a current to the light emitting load according to a PWM dimming signal.

5. A power conversion apparatus comprising:
a first DC converter configured to electrically insulate an AC power source and a light emitting load that emits light under a predetermined DC voltage from each other, convert an AC voltage from the AC power source into the predetermined DC voltage, correct a power factor, and supply the predetermined DC voltage to the light emitting load;
a plurality of loads configured to operate under low DC voltages; and
a third DC converter configured to electrically insulate the AC power source and the plurality of loads from each other, convert the AC voltage from the AC power source into at least one low DC voltage, and supply the at least one low DC voltage to at least one of the plurality of loads.

6. The power conversion apparatus of claim 5, further comprising:
a fourth DC converter configured to convert the predetermined DC voltage from the first DC converter into one or more low DC voltages to drive one or more of the plurality of loads,
the one or more of the plurality of loads being connected to an output side of the fourth DC converter.

7. The power conversion apparatus of claim 5, wherein the first DC converter comprises:
a transformer configured to insulate primary and secondary sides from each other;
a current detector arranged on the secondary side of the transformer and configured to detect a current passing through the light emitting load;
an error amplifier configured to amplify an error between the current value detected by the current detector and a reference current value;
a signal transmission insulating element configured to transmit a control signal based on an output signal of the error amplifier to the primary side of the transformer; and
a switching element arranged on the primary side of the transformer and configured to turn on/off according to the control signal transmitted from the signal transmission insulating element, to transmit power through the transformer to the secondary side of the transformer.

8. The power conversion apparatus of claim 7, wherein the first DC converter further comprises:
a time division circuit arranged on the secondary side of the transformer and configured to intermittently supply a current to the light emitting load according to a PWM dimming signal.

9. A power conversion apparatus comprising:
a second DC converter configured to electrically insulate an AC power source and a light emitting load that emits light under a predetermined DC voltage from each other, convert an AC voltage from the AC power source into the predetermined DC voltage, and supply the predetermined DC voltage to the light emitting load;
a plurality of loads configured to operate under low DC voltages; and
a third DC converter configured to electrically insulate the AC power source and the plurality of loads from each other, convert the AC voltage from the AC power source into at least one low DC voltage, and supply the at least one low DC voltage to at least one of the plurality of loads.

10. The power conversion apparatus of claim 9, further comprising
a fourth DC converter configured to convert the predetermined DC voltage into a low DC voltage to drive at least another of the plurality of loads that being connected to an output side of the fourth DC converter.

11. The power conversion apparatus of claim 9, wherein the second DC converter comprises:
a transformer configured to insulate primary and secondary sides from each other;
a current detector arranged on the secondary side of the transformer and configured to detect a current passing through the light emitting load;
an error amplifier configured to amplify an error between the current value detected by the current detector and a reference current value;
a signal transmission insulating element configured to transmit a control signal based on an output signal of the error amplifier to the primary side of the transformer; and
a switching element arranged on the primary side of the transformer and configured to turn on/off according to the control signal transmitted from the signal transmission insulating element, to transmit power through the transformer to the secondary side of the transformer.

12. The power conversion apparatus of claim 11, wherein the second DC converter further comprises
a time division circuit arranged on the secondary side of the transformer and configured to intermittently supply a current to the light emitting load according to a PWM dimming signal.
